(19) United States
(12) Patent Application Publication
(10) Pub. No.: US 2013/0111863 A1
(43) Pub. Date: May 9, 2013

(54) Disc Mower Blades

(71) Applicant: Kondex Corporation, Lomira, WI (US)

(72) Inventors: Keith A. Johnson, Kewaskum, WI (US); Neal J. Stoffel, Cambellsport, WI (US)

(73) Assignee: Kondex Corporation, Lomira, WI (US)

(21) Appl. No.: 13/670,643

(22) Filed: Nov. 7, 2012

Related U.S. Application Data
(60) Provisional application No. 61/556,348, filed on Nov. 7, 2011.

(51) Int. Cl. A01D 34/73; A01D 34/76

(52) U.S. Cl. 56/10.1; 56/295

(57) ABSTRACT

An improved cutter blade or disc mower blade is provided having structure to reduce the tendency of vegetation to slip off and around the blade edge and tip. The disc mower blade is attached to a rotary cutter module and driven by a mowing machine. In one aspect of the disc mower blade, the disc mower blade includes a knife edge with serrations distributed along the edge such that vegetation does not slide along the edge during operation of the mowing machine. Further, another aspect of the mower blade is that the knife edge may be curved so as to prevent the vegetation from sliding along the edge during operation of the mowing machine. In another aspect, the disc mower blade includes a winglet disposed at a tip of the blade such that vegetation cannot slide past the blade during operation of the mowing machine.

### CROSS-REFERENCE TO RELATED PATENT APPLICATIONS

This patent application claims the benefit of U.S. Provisional Patent Application No. 61/556,348, filed Nov. 7, 2011, the entire teachings and disclosure of which are incorporated herein by reference thereto.

### FIELD OF THE INVENTION

This invention generally relates to disc mower blades (also referred to as knives).

### BACKGROUND OF THE INVENTION

Generally, disc style cutter bars are used on a mowing machine to sever standing crops in an agricultural setting or grass in a lawn application. A disc style cutter bar typically includes several rotating discs that carry cutter blades that sever standing crops upon impact.

In the use of these mowing machines, the cutter blades are subjected to extreme abrasive wear conditions particularly concentrated at the tip of the cutter blade. This leads to the tip of the cutter blade becoming dull prior to the rest of the blade. Because the tip of the blade is dull, the crops being cut tend to slide past the outer edge of the cutter blade. The sliding effect causes further wear and dulling of the tip of the blade because the crops are sliding off the end of the blade as opposed to being cut. Further, the stalks of the plant tend to be abrasive in and of themselves, which also contributes to the dulling of the cutter blade.

Furthermore, because the cutter blades are worn and dull at the tip causing the crops to slide past the tip instead of being severed, there is a cutting efficiency loss. This cutting efficiency loss also results in a non-clean cut that is not at a consistent height from ground level, where the crops are anchored by their root structure. This further harms the re-growth effort of the crop. Also, because the cutter blades are not cutting the crop upon impact, the crops slide to the dullest part of the blade to sever the crop, which leads to a higher required force to keep the discs spinning at the desired velocity. The higher force required leads to higher horse power requirements and increased fuel usage that in turn increase component and maintenance costs for the mowing machine. The present invention is directed toward improvements in the disc mower cutting blades (also referred to as knives).

Examples of disc mowers that employ disc mower cutting blades are shown in the following U.S. patents and publications: U.S. Pat. Nos. 5,778,647; 5,782,071; 5,953,893; 2006/0021316; 2007/0277492; and 2011/0173940. The entire disclosure of each of these U.S. patents and publications is hereby incorporated by reference in their entireties. As generally shown, these types of disc mower cutting blades are used in agricultural applications, but may also be used in lawn applications.

### BRIEF SUMMARY OF THE INVENTION

In one aspect, embodiments of the invention provide a disc mower cutter blade for cutting vegetation. The disc mower cutter blade includes a disc mower cutter blade body that has a mounting aperture, and a knife cutting edge spaced from the mounting aperture. The knife cutting edge extends toward a tip of the disc mower cutter blade. The disc mower cutter blade further includes a means for reducing the tendency of vegetation from slipping off and around the knife cutting edge and the tip.

In various embodiments, the means for reducing the tendency of vegetation to slip off and around the knife cutting edge and tip includes at least one of: (1) a plurality of serrations distributed along the knife cutting edge, (2) a concave curvature formed into the knife cutting edge, and/or (3) a winglet integrally formed into the blade body at a tip end remote from the mounting aperture.

In a particular embodiment, the disc mower cutter blade body may include a mounting body section, a transition section, and a knife section. The mounting body section defines a first plane, and the knife section defines a second plane. The first and the second planes are angularly offset between 0 and 30 degrees.

Further, the knife section may be bent at a bend to include a leading section at least partially including the knife cutting edge and a trailing section. The trailing section defines said second plane, and the leading section defines a third plane. The third plane and the first plane are angularly offset between 0 and 10 degrees. Also, the cutting edge is formed along a tapered cutting face that forms a rake angle of between 15 and 45 degrees.

Additionally, the means for reducing the tendency of vegetation from slipping off and around the knife cutting edge and the tip include a concave curvature formed at least partially into the leading section. The concave curvature extends at a radius of curvature of between 1 and 3 inches in certain embodiments, and in other embodiments, the radius of curvature extends between 3 and 10 inches.

Furthermore, a triangular shaped winglet is formed at a terminating tip end remote from the mounting aperture. The winglet is defined in the leading section with extents thereof defined by the cutting edge, a distal tip edge of the disc mower cutter blade body, and the bend.

In another aspect, embodiments of the invention provide a disc mower cutter blade for cutting vegetation. The disc mower cutter blade includes a disc mower cutter blade body that has a mounting aperture, and a knife cutting edge spaced from the mounting aperture. The knife cutting edge extends toward a tip and has a concave curvature formed therein.

In yet another aspect, embodiments of the invention provide a mowing machine for cutting vegetation including the disc mower cutter blade, as described according to any aspect above or otherwise as herein. The mowing machine includes a drive unit, a rotary cutter bar, and at least one rotary cutter module. The rotary cutter bar is operably connected to the drive unit such that the drive unit drives the rotary cutter bar. The at least one rotary cutter module is operably connected to the rotary cutter bar, and configured to rotate about a rotary cutting axis. The disc mower cutter blade is mounted to the at least one rotary cutter module.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is an illustration of a tractor pulling a mower;

FIG. 2 is an illustration of a disc mower cutter bar including a plurality of discs holding a plurality of cutter blades;

FIG. 3 is a schematic view of a mowing machine;

FIG. 4 is an isometric view of a rotary cutter module including disc mower cutter blades according to a first embodiment;

FIGS. 5-6 are isometric views of a disc mower cutter blade according to a first embodiment;

FIGS. 7-10 are a perspective view, an end view, top view and front side elevation view of the disc mower cutting blade according to the first embodiment shown in FIGS. 3-4;

FIGS. 11-13 are a top view, a cross-sectional view, and a side view of a disc a mower cutting blade according to a second embodiment;

FIGS. 14-19 are a top view, an up-close view, a cross-sectional view, a perspective view, a side view, and a back view of a mower cutting blade according to a third embodiment;

FIGS. 20-21 are isometric views of a disc mower cutting blade according to a fourth embodiment; and

FIGS. 22-25 are a perspective view, an end view, top view, and front elevation view of the disc mower cutting blade according to the fourth embodiment shown in FIGS. 20-21.

It is understood that these cutting blades may be arranged for either direction of rotation and there is a left and right version of each design.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

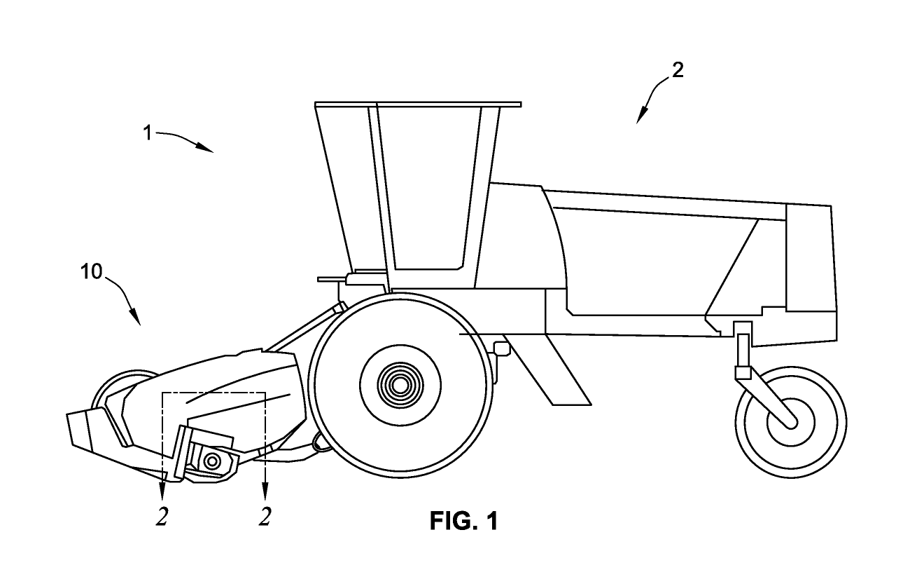

FIG. 1 illustrates a tractor pulling a mowing machine 1 that includes a tractor 2 and a mowing machine 10. The mowing machine 10 may either be self-propelled or pulled/powered by the tractor 2.

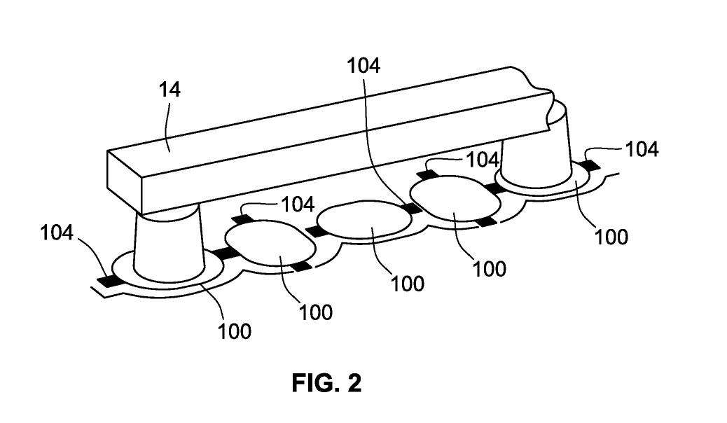

FIG. 2 illustrates a disc cutter bar 14. Disc cutter bar 14 supports a plurality of rotary cutter modules 100, which in turn support a plurality of curter blades 104. Disc cutter bar 14 is part of the mowing machine 10, from FIG. 1.

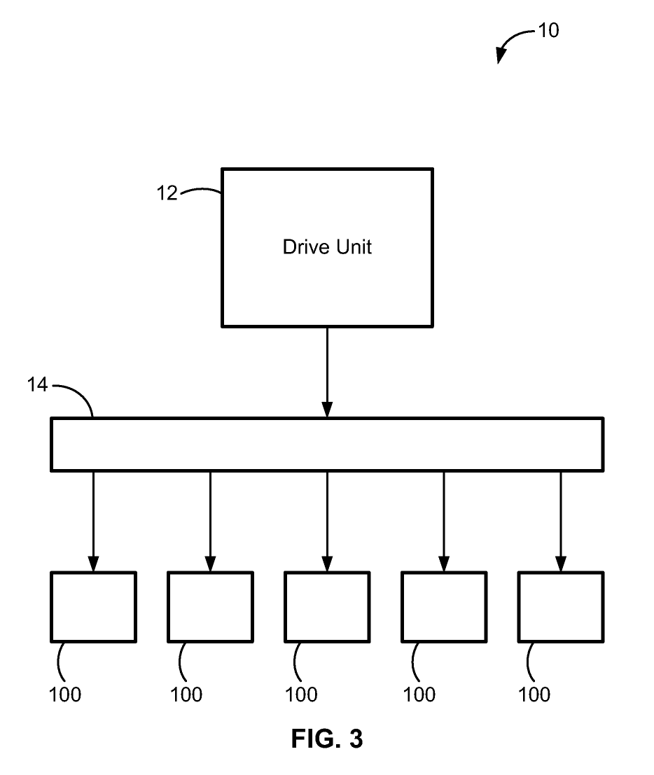

FIG. 3 illustrates a schematic view of a mowing machine 10. The mowing machine 10 includes a drive unit 12 for driving a rotary cutter bar 14. The rotary cutter bar 14 includes a plurality of rotary cutter modules 100 that each contain a plurality of cutter blades 104 (see FIG. 2). While the mowing machine 10 is illustrated as including a plurality of rotary cutter modules 100, it is contemplated that as few as one rotary cutter module 100 could be employed in certain applications.

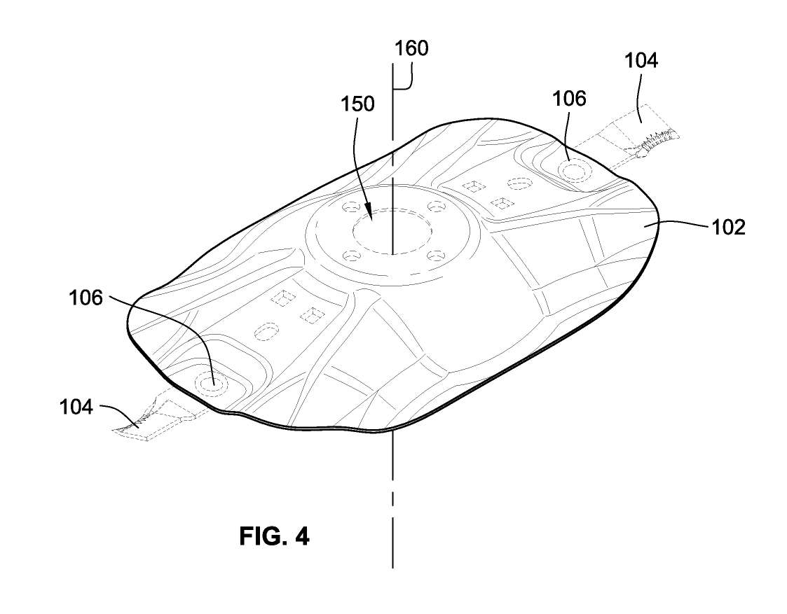

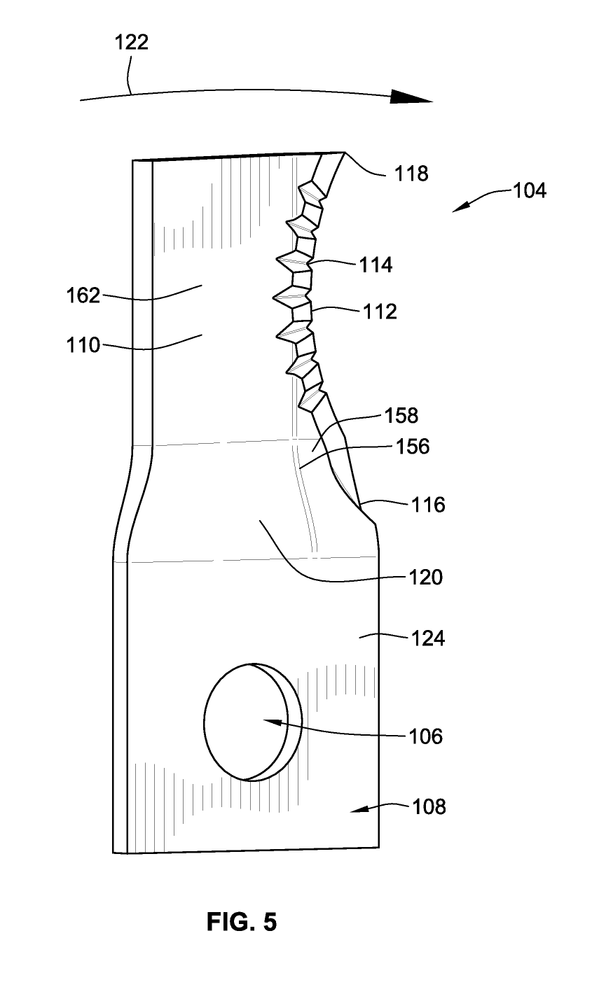

FIG. 4 illustrates an isometric view of the rotary cutter module 100 including cutter blades 104. Cutter blades 104 are mounted on the rotary cutter module body 102. The cutter blades 104 are anchored to the rotary cutter module body 102 by mounting aperture 106. Typically, mounting aperture 106 is a hole or slot cut into a body 108 (see FIG. 5) of the cutter blade 104. In the configuration where the mounting aperture 106 is a hole, the hole generally has a diameter of between 0.5 and 1.5 inches.

Further, the rotary cutter module 100 includes an attachment mechanism 150, which attaches to the rotary cutter bar 14 (see FIGS. 2-3) that is in turn driven by the drive unit 12. The drive unit 12 causes the rotary cutter module 100 to rotate about a rotary cutting axis 160. Also, the cutter blades are mounted transversely to the rotary cutting axis 160, and the mounting aperture 106 is positioned toward a bottom of the body 108 to balance the cutter blade 104 such that during rotation, the cutter blades 104 will extend under centripetal force. As the rotary cutter module 100 is brought into contact with a crop or foliage to be mowed, the cutter blades 104 will impact the crop or foliage thereby severing an upper portion of the crop or foliage from its root system.

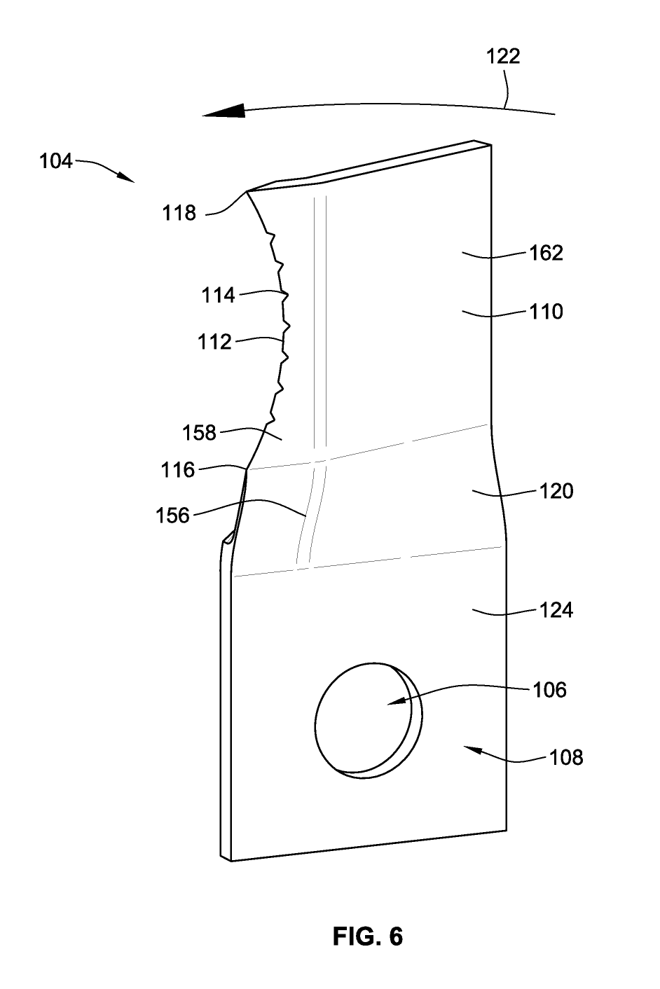

FIGS. 5-10 illustrate various views of the cutter blade 104. FIG. 5 illustrates an up-close view of the front side of the cutter blade 104, and FIG. 6 illustrates an up-close view of the back side of the cutter blade 104. As can be seen in the views from FIGS. 5-6, cutter blade 104 includes a disc mower cutter blade body 108, which includes a mounting body section 124 that includes the mounting aperture 106. The mounting body section 124 is attached to a knife section 110 by a transition section 120. The mounting body section 124 defines a first plane 152 and the knife section 110 generally defines a second plane 154 (see FIG. 8). The angle between the first plane 152 and the second plane 154 can be between 10 and 30 degrees, and more preferably between 15 and 25 degrees. In a specific embodiment, the angle between the first plane 152 and the second plane 154 is 18 degrees.

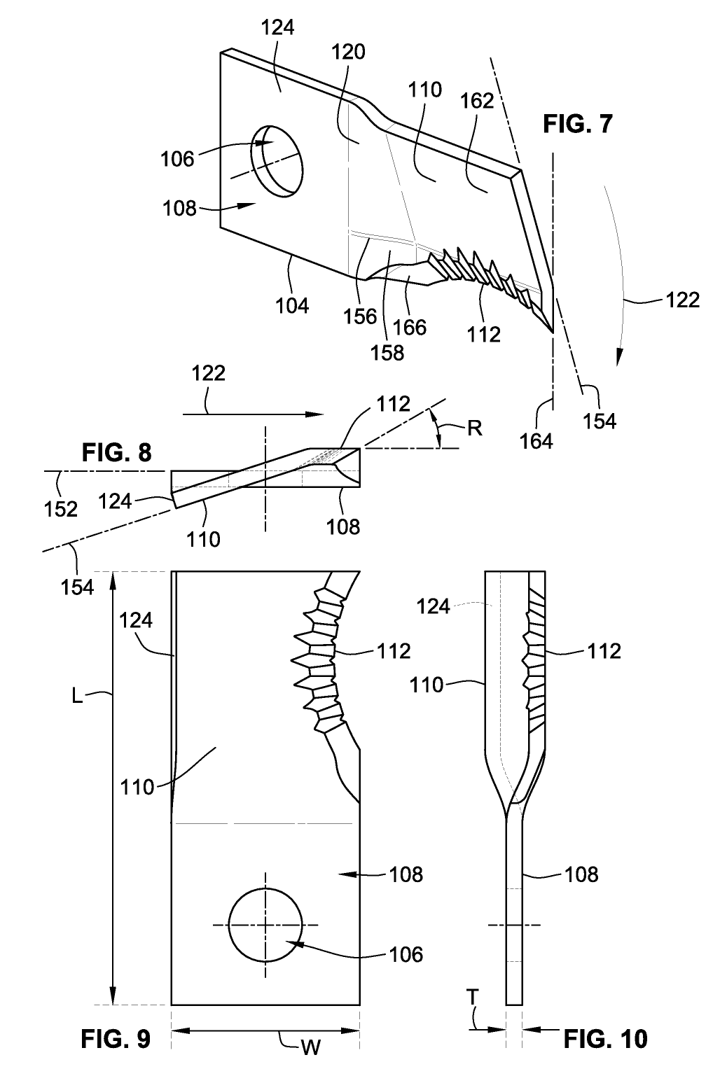

The knife section 110 includes a knife cutting edge 112, which is part of a leading section 158, and a trailing section 162. The trailing section 162 trails the leading section 158 in a direction of rotation 122. Also, the trailing section 162 specifically defines the second plane 154. The leading section 158 comprises a curved cutting structure and extends forwardly or rearwardly between a bend 156 and the knife edge 112. The leading section 158 defines a third plane 164, as best seen in FIG. 7. An angle between the third plane 164 and the first plane 152 is between 0 and 10 degrees.

Furthermore, the knife cutting edge 112 is formed along a tapered cutting face 166. The tapered cutting face 166 forms a rake angle R of between 15 and 45 degrees. The knife cutting edge 112 also includes a pattern of serrations 114. The serrations 114 are distributed along the knife edge 112 from a knife edge base 116 to a knife tip 118. The serrations 114 may span a length from the knife cutting edge 112 to past the bend 156.

Additionally, the knife edge 112 is inwardly curved or in other words concave to the direction of rotation 122. The curvature extends between the knife edge base 116 to the knife tip 118. Specifically, the knife edge 112 has a radius of curvature between 1.0 and 3.0 inches and preferably between 1.5 and 2.0 inches and even more preferably has a radius of curvature of 1.7 inches. Typically, serrations 114 are distributed along the curvature at an angular spacing of between 3 and 14 degrees. In some embodiments, between 5 and 10 serrations may be provided.

The disc mower cutter blade body 108 also includes an integrally formed winglet 168 created by virtue of the curvature of the knife edge 112. The winglet 168 is generally triangular in shape and disposed at a terminating tip region of the knife tip 118 and includes part of the knife cutting edge 112. The winglet 168 is part of the leading section 158 of the knife cutting edge 112 and is defined by the bend 156, knife cutting edge 112, and a distal edge of the tip 118 of the disc mower cutter blade body 108. As such, the winglet 168 acts as a dam or fence to catch the crop and stop it from slipping off and around the knife cutting edge 112 and tip 118.

Generally, the cutter blade 104 includes a length L between 3.5 inches and 5.0 inches, a width W between 1.5 inches and 3.0 inches, and a thickness T between 0.1 inches and 0.2 inches. These dimensions allow cutter blade 104 make it particularly adapted for use as a mower cutter blade.

During operation, the cutter blade 104 rotates in a cutting direction 122, which is transverse to the rotary cutting axis 160 (see FIG. 4) and parallel to the ground where the crop is planted. As the cutter blade 104 is brought into a proximate location to the crops to be mowed, the crop body will impact the knife cutting edge 112. The serrations 114, the radius of curvature of the knife cutting edge 112, and the winglet 168 tend to snag the crop as opposed to allowing the crop to slide along the knife cutting edge 112 and past the tip 118 of the cutter blade 104. This results in the crop being severed upon impact by the knife cutting edge 112.

While in certain embodiments of the cutter blade 104, the serrations 114, the radius of curvature of the knife cutting edge 112, and the winglet 168 will all be utilized to prevent the crop from sliding, each of these features are independently capable of preventing the crop from sliding. As such, each of the serrations 114, the radius of curvature of the knife cutting edge 112, and the winglet 168 may be used alone or in any permutation in order to prevent the tendency of vegetation from slipping off and around the knife cutting edge 112 and the tip 118.

By cutting the crop upon impact, the cutter blade 104 will not prematurely wear and dull at the knife tip 118. Further, the serrations 114 cause a self-sharpening effect on the knife edge 112 of the cutter blade 104.

Furthermore, because the transition section 120 and the bend 156 angularly offset the knife section 110 from the mounting section 124, the cutter blade 104 will have improved aerodynamics. Also, the winglet 168 acts to improve the aerodynamics as well. Specifically, the angular offset and the winglet 168 aide in reducing the effect of air turbulence and vortexes coming off the end of the cutter blade 104, as the cutter blade 104 is rotated. This is especially important for light weight crops because the air turbulence and the vortexes tend to blow the light crop away from the cutter blade 104 to potentially leave some portion of the crops to be mowed uncut.

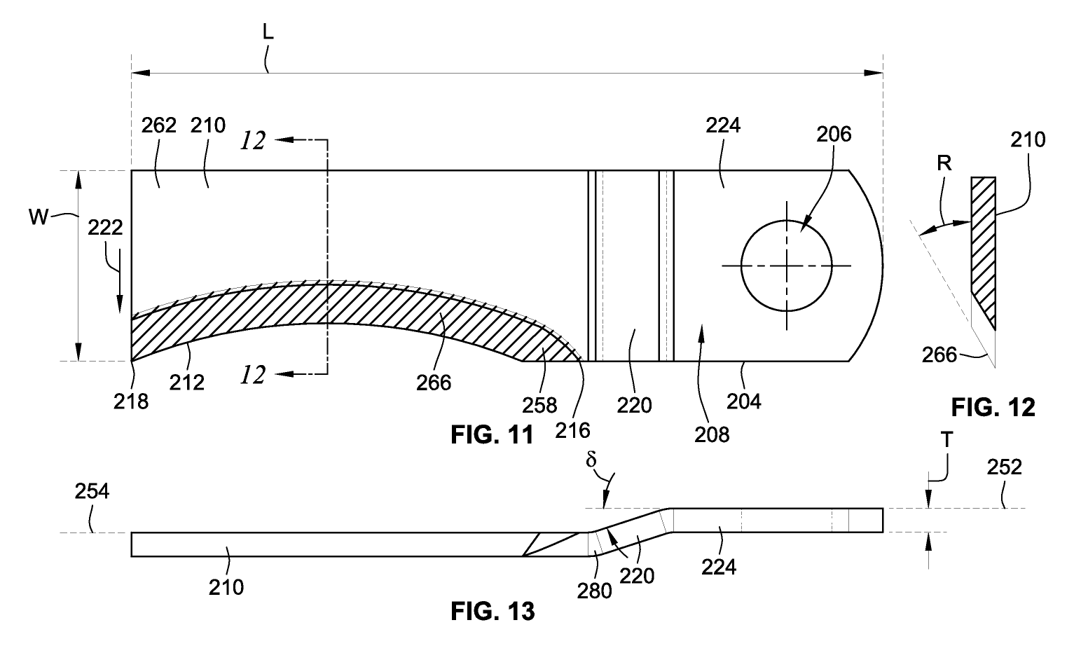

FIGS. 11-13 illustrate a second embodiment in a cutter blade 204. Cutter blade 204 is sized so to optimize the cutting of larger vegetation, such as corn stalks. Cutter blade 204 includes a disc mower cutter blade body 208, which includes a mounting body section 224 that includes the mounting aperture 206. Mounting aperture 206 is generally circular and has a diameter between 1.0 and 3.0 inches.

The mounting body section 224 is attached to a knife section 210 by a transition section 220. The mounting body section 224 defines a first plane 252 and the knife section 210 generally defines a second plane 254 (see FIG. 13). Generally, the first plane 252 and the second plane 254 are parallel. The distance between the first plane 252 and the second plane 254 is defined by the transition section 220, which is angled, at an angle delta, relative to the first plane 252 between 10 and 25 degrees. Furthermore, the knife section 210 attaches to the transition section 220 at a curved section 280, which has a radius of curvature between 0.1 and 0.5 inches.

The knife section 210 includes a knife cutting edge 212, which is part of a leading section 258, and a trailing section 262. The trailing section 262 trails the leading section 258 in a direction of rotation 222.

Furthermore, the knife cutting edge 212 is formed along a tapered cutting face 266, as seen in FIG. 12. The tapered cutting face 266 forms a rake angle R of between 15 and 45 degrees.

Additionally, the knife edge 212 is inwardly curved or in other words concave to the direction of rotation 222. The curvature extends between the knife edge base 216 to the knife tip 218. Specifically, the knife edge 212 has a radius of curvature between 3.0 and 10.0 inches and preferably between 5.0 and 8.0 inches and even more preferably has a radius of curvature of 6.8 inches.

Generally, the cutter blade 204 includes a length L between 5.0 inches and 15.0 inches, a width W between 1.5 inches and 4.5 inches, and a thickness T between 0.1 inches and 0.5 inches. These dimensions make cutter blade 204 particularly adapted for use as a mower cutter blade.

During operation, the cutter blade 204 rotates in a cutting direction 222, which is transverse to the rotary cutting axis 160 (see FIG. 4) and parallel to the ground where the crop is planted. As the cutter blade 204 is brought into a proximate location to the crops to be mowed, the crop body will impact the knife cutting edge 212. The radius of curvature of the knife cutting edge 212 tends to snag the crop as opposed to allowing the crop to slide along the knife cutting edge 212 and past the tip 218 of the cutter blade 204. This results in the crop being severed upon impact by the knife cutting edge 212.

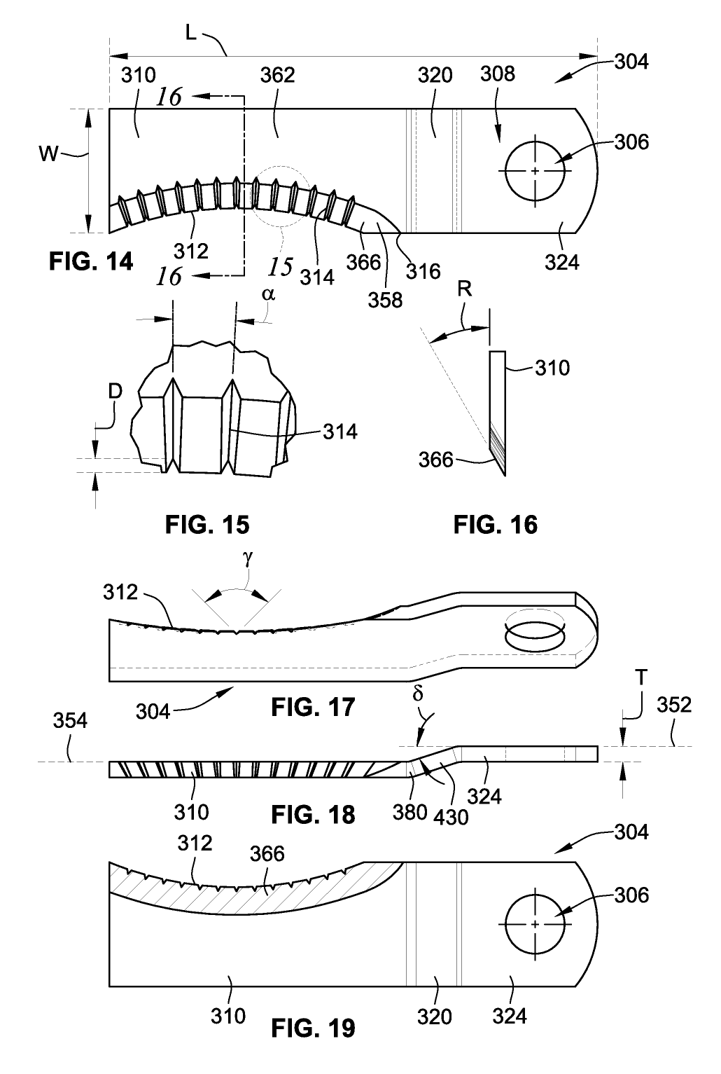

FIGS. 14-19 illustrate a cutter blade 304, which is similar to cutter blade 204 from FIGS. 11-13. A difference between cutter blade 304 and cutter blade 204 is the addition of serrations 314.

Cutter blade 304 is sized so to optimize the cutting of larger vegetation, such as corn stalks. Cutter blade 304 includes a disc mower cutter blade body 308, which includes a mounting body section 324 that includes the mounting aperture 306. Mounting aperture 306 is generally circular in shape and includes a diameter of between 1.0 and 3.0 inches.

The mounting body section 324 is attached to a knife section 310 by a transition section 320. The mounting body section 324 defines a first plane 352 and the knife section 310 generally defines a second plane 354 (see FIG. 18). Generally, the first plane 352 and the second plane 354 are parallel. The distance between the first plane 352 and the second plane 354 is defined by the transition section 320, which is angled, at an angle delta, relative to the first plane 352 between 10 and 25 degrees. Furthermore, the knife section 310 attaches to the transition section 320 at a curved section 380, which has a radius of curvature between 0.1 and 0.5 inches.

The knife section 310 includes a knife cutting edge 312, which is part of a leading section 358, and a trailing section 362. The trailing section 362 trails the leading section 358 in a direction of rotation 322.

Furthermore, the knife cutting edge 312 is formed along a tapered cutting face 366, as seen in FIG. 16. The tapered cutting face 366 forms a rake angle R of between 15 and 45 degrees. The knife cutting edge 312 also includes a pattern of serrations 314. The serrations 314 are distributed along the knife edge 312 from a knife edge base 316 to a knife tip 318. In the top view of the cutter blade 304 illustrated at FIG. 14, the serrations 314 span a length from the knife cutting edge 312 to past the tapered cutting surface 366. In the back view of the cutter blade 304 illustrated at FIG. 19, the serrations 314 do not have as great of a length as the top side shown in FIG. 14.

Additionally, the knife edge 312 is inwardly curved or in other words concave to the direction of rotation 322. The curvature extends between the knife edge base 316 to the knife tip 318. Specifically, the knife edge 312 has a radius of curvature between 3.0 and 10.0 inches and preferably between 5.0 and 8.0 inches and even more preferably has a radius of curvature of 6.8 inches.

Typically, serrations 314 are distributed along the curvature at an angular spacing of alpha, which ranges between 1 and 14 degrees, as illustrated in FIG. 15. In some embodiments, between 5 and 20 serrations may be provided. Also, the individual serrations 314 along the knife edge 312 have a depth D between 0.04 and 0.14 inches, as illustrated in FIG. 15. Also, the serrations 314 include an angle gamma, as illustrated in FIG. 17, which is the inner angle of the serration 314 and is between 70 and 110 degrees.

Generally, the cutter blade 304 includes a length L between 5.0 inches and 15.0 inches, a width W between 1.5 inches and 4.5 inches, and a thickness T between 0.1 inches and 0.5 inches. These dimensions make cutter blade 304 particularly adapted for use as a mower cutter blade.

During operation, the cutter blade 304 rotates in a cutting direction 322, which is transverse to the rotary cutting axis 160 (see FIG. 4) and parallel to the ground where the crop is planted. As the cutter blade 304 is brought into a proximate location to the crops to be mowed, the crop body will impact the knife cutting edge 312. The serrations 314 and the radius of curvature of the knife cutting edge 312 tend to snag the crop as opposed to allowing the crop to slide along the knife cutting edge 312 and past the tip 318 of the cutter blade 304. This results in the crop being severed upon impact by the knife cutting edge 312.

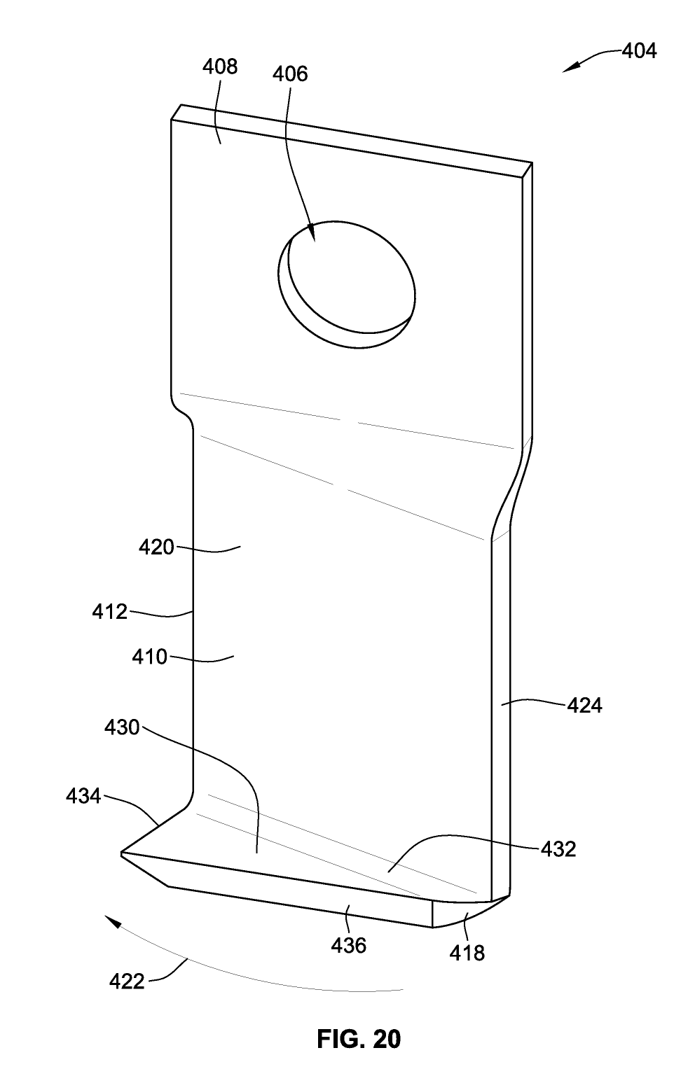

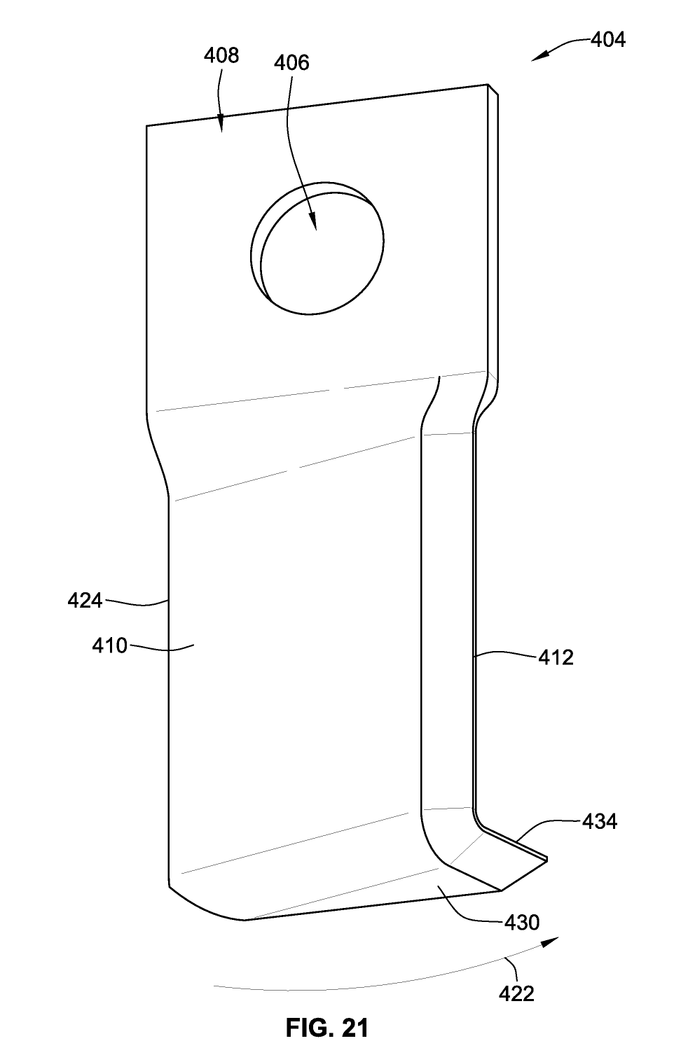

FIGS. 20-21 illustrate another embodiment of the present invention in cutter blade 404. FIG. 20 illustrates a front side 420 of the cutter blade 404, and FIG. 21 illustrates a back side 422 of the cutter blade 404. Further, cutter blade 404 includes a body portion 408 and a knife portion 410, similar to cutter blade 104 (see FIGS. 5-6). Generally, cutter blade 404 has a total length L between 3.0 to 6.0 inches, a thickness T of between 0.05 and 0.50 inches, and a width W of between 0.5 and 3.0 inches. These dimensions allow cutter blade 404 to be particularly adapted for use as a mower cutter blade.

Further, cutter blade 404 may be adapted to cut more substantial vegetation such as corn stalks. In this implementation, cutter blade 404 will have dimensions similar to cutter blades 204 and 304 (see FIGS. 11 and 14). Cutter blade 404, in this implementation, will have a length L between 5.0 inches and 15.0 inches, a width W between 1.5 inches and 4.5 inches, and a thickness T between 0.1 inches and 0.5 inches.

As can be seen in both FIGS. 20-21, cutter blade 404 includes a winglet 430 disposed at a distal end of the cutter blade 404 incorporating a portion of the knife edge 412. Winglet 430 includes a knife edge 436, which is an extension of the knife edge 412. Both of the knife edge 436 and the knife edge 412 include a tapered cutting face 466. The tapered cutting face 466 forms a rake angle R of between 15 and 45 degrees.

Further, the winglet 430 includes a back side 434 and a connecting portion 432, which connects the winglet 430 to the knife body 410. The knife edge 436, back side 434, and connecting portion 432 form an outer triangular boundary of the winglet 430. Typically, winglet 430 is between 0.25 and 1.25 inches in length in a vertical direction normal to the front side 420 of knife portion 410.

Additionally, winglet 430 extends from the knife portion 410 transversely to a cutting direction 422 at the connecting portion 432 with a radius of curvature between 0.050 and 0.125 inches. As such, the winglet 430 acts as a dam or fence to catch the crop and stop it from slipping past a knife tip 418 of the knife edge 412.

Also, the winglet 430 is formed from additional material located at a point that is radially distal from an aperture mounting 406, which operates similarly to the aperture mounting 106, 206, and 306 (see FIGS. 5-6, 11, and 14). Therefore, this additional material located as described will increase the rotational inertia and help to keep the cutter blade 404 extended while rotating into the crop being cut in the direction of rotation 422.

Furthermore, the winglet 430 acts to reduce air turbulence and vortexes coming off the end of the cutter blade 404. As mentioned previously, this is especially important when cutting light weight crops because the turbulence and vortexes of the cutter blade 404 have a tendency to blow the light weight crop away from the cutter blade 404 thereby leaving streaks of uncut crop.

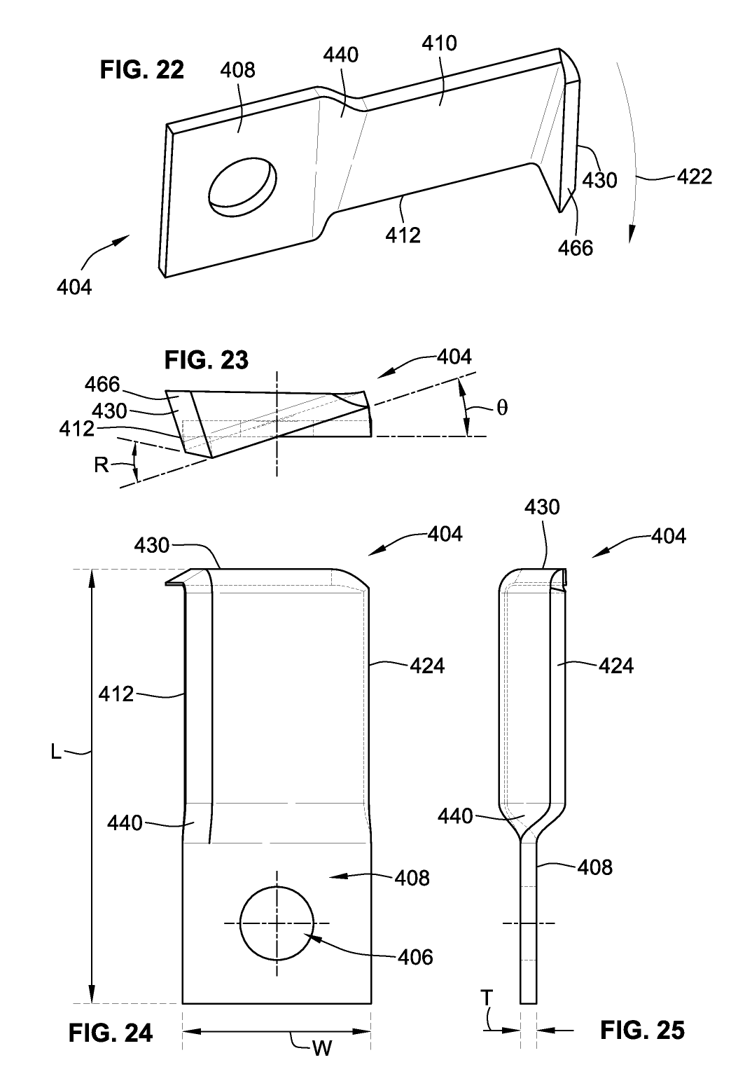

FIGS. 22-25 illustrate a perspective view, an end view, top view, and front elevation view of the cutter blade 404 shown in FIGS. 9-10, respectively. As particularly shown in FIGS. 22-23 and 25, it can be seen that the knife edge 412 of the knife portion 410 is angularly offset from the body portion 408 at an angle theta that is between 10 and 25 degrees. The knife portion 410 is angular offset from the body portion 408 by an intermediate twist section 440, which acts as a transition region that transitions an angle of the knife portion 410 relative to the body portion 408. By angularly offsetting the knife edge 412 from the body portion 408, the cutter blade 404 will have improved aerodynamics. The improved aerodynamics of the cutter blade 404 further reduces the potential to leave uncut crops.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A disc mower cutter blade for cutting vegetation, comprising:
a disc mower cutter blade body having a mounting aperture;
a knife cutting edge spaced from the mounting aperture, the knife cutting edge extending toward a tip; and
means for reducing the tendency of vegetation from slipping off and around the knife cutting edge and the tip.

2. The disc mower cutter blade of claim 1, wherein the disc mower cutter blade body includes a mounting body section, a transition section and a knife section, the mounting body section defining a first plane and the knife section defining a second plane, the first and second planes being angularly offset between 10 and 30 degrees.

3. The disc mower cutter blade of claim 2, wherein the knife section is bent at a bend to include a leading section at least partially including the knife cutting edge and a trailing section, the trailing section defining said second plane, wherein the leading section defines a third plane, the third plane and the first plane being angularly offset between 0 and 10 degrees.

4. The disc mower cutter blade of claim 3, wherein the cutting edge formed into the knife section is formed along a tapered cutting face that forms a rake angle of between 15 and 45 degrees.

5. The disc mower cutter blade of claim 1, wherein said reducing means comprises at least one of a plurality of serrations distributed along the knife cutting edge, a concave curvature formed into the knife cutting edge, and a winglet integrally formed into the blade body at a tip end remote from the mounting aperture.

6. The disc mower cutter blade of claim 3, wherein said reducing means comprises the plurality of serrations distributed along the knife cutting edge, and the concave curvature formed into the knife cutting edge, wherein the serrations are distributed along the concave curvature at an angularly spacing of between 3 and 14 degrees.

7. The disc mower cutter blade of claim 1, wherein said reducing means comprise a concave curvature formed into the knife cutting edge, the concave curvature extending at a radius of curvature of between 1 and 3 inches.

8. The disc mower cutter blade of claim 1, wherein said reducing means comprise a concave curvature formed into the knife cutting edge, the concave curvature extending at a radius of curvature of between 3 and 10 inches.

9. The disc mower cutter blade of claim 1, wherein, the blade has the following dimensions:
(a) a length of between 3.5 and 5.0 inches;
(b) a width of between 1.5 and 3.0 inches;
(c) a thickness of between 0.1 and 0.2 inches; and
(d) a mounting aperture diameter of between 0.5 and 1.0 inch.

10. The disc mower cutter blade of claim 1, wherein, the blade has the following dimensions:
(a) a length of between 5.0 and 15.0 inches;
(b) a width of between 1.5 and 4.5 inches;
(c) a thickness of between 0.1 and 0.5 inches; and
(d) a mounting aperture diameter of between 1.0 and 3.0 inches.

11. The disc mower cutter blade of claim 1, wherein the disc mower cutter blade body includes a mounting body section, a transition section and a knife section, the mounting body section defining a first plane and the knife section defining a second plane, the first and second planes being angularly offset between 0 and 30 degrees, wherein the knife section is bent at a bend to include a leading section at least partially including the knife cutting edge and a trailing section, the trailing section defining said second plane, wherein the leading section defines a third plane, the third plane and the first plane being angularly offset between 0 and 10 degrees, wherein the cutting edge is formed along a tapered cutting face that forms a rake angle of between 15 and 45 degrees, and wherein said reducing means comprise a concave curvature formed at least partially into the leading section, the concave curvature extending at a radius of curvature of between 1 and 3 inches, wherein a triangular shaped winglet is formed at a terminating tip end remote from the mounting aperture, the winglet being defined in the leading section with extents thereof defined by the cutting edge, a distal tip edge of the disc mower cutter blade body, and said bend.

12. A disc mower cutter blade for cutting vegetation, comprising:
a disc mower cutter blade body having a mounting aperture;
a knife cutting edge spaced from the mounting aperture, the knife cutting edge extending toward a tip; and
a concave curvature formed into the knife cutting edge.

13. The disc mower cutter blade of claim 12, wherein the concave curvature extends at a radius of curvature of between 1 and 3 inches.

14. The disc mower cutter blade of claim 13, further comprising a plurality of serrations distributed along the concave curvature at an angularly spacing of between 3 and 14 degrees.

15. The disc mower cutter blade of claim 12, wherein, the blade has the following dimensions:
(a) a length of between 3.5 and 5 inches;
(b) a width of between 1.5 and 3 inches;
(c) a thickness of between 0.1 and 0.2 inches; and
(d) a mounting aperture diameter of between 0.5 and 1 inch.

16. The disc mower cutter blade of claim 12, wherein, the blade has the following dimensions:
(a) a length of between 5.0 and 15.0 inches;
(b) a width of between 1.5 and 4.5 inches;
(c) a thickness of between 0.1 and 0.5 inches; and
(d) a mounting aperture diameter of between 1.0 and 3.0 inches.

17. The disc mower cutter blade of claim 12, wherein the disc mower cutter blade body includes a mounting body section, a transition section and a knife section, the mounting body section defining a first plane and the knife section defining a second plane, the first and second planes being angularly offset between 10 and 30 degrees.

18. The disc mower cutter blade of claim 17, wherein the knife section is bent at a bend to include a leading section at least partially including the knife cutting edge and a trailing section, the trailing section defining said second plane, wherein the leading section defines a third plane, the third plane and the first plane being angularly offset between 0 and 10 degrees.

19. The disc mower cutter blade of claim 18, wherein the cutting edge formed into the knife section is formed along a tapered cutting face that forms a rake angle of between 15 and 45 degrees.

20. The disc mower cutter blade of claim 12, wherein the cutting edge is formed at least partially into a knife section, the knife section being bent at a bend to include a leading section at least partially including the knife cutting edge and a trailing section.

21. The disc mower cutter blade of claim 20, wherein the cutting edge formed into the knife section is formed along a tapered cutting face, the bend running at least partially through the cutting face at an intermediate portion of the cutting face, and wherein a triangular shaped winglet is formed at a terminating tip end remote from the mounting aperture, the winglet being defined in the leading section with extents thereof defined by the cutting edge, a distal tip edge of the disc mower cutter blade body, and said bend.

22. A mowing machine for cutting vegetation including the disc mower cutter blade of claim 1, the mowing machine comprising:
a drive unit;
a rotary cutter bar operably connected to the drive unit such that the drive unit drives the rotary cutter bar;
at least one rotary cutter module operably connected to the rotary cutter bar, the at least one rotary cutter module configured to rotate about a rotary cutting axis; and
the disc mower cutter blade being mounting to the at least one rotary cutter module.

23. A mowing machine for cutting vegetation including the disc mower cutter blade of claim 12, comprising:
a drive unit;
a rotary cutter bar operably connected to the drive unit such that the drive unit drives the rotary cutter bar;
at least one rotary cutter module operably connected to the rotary cutter bar, the at least one rotary cutter module configured to rotate about a rotary cutting axis; and
the disc mower cutter blade being mounted to at least one rotary cutter module.
